(19) United States
(12) Patent Application Publication
(10) Pub. No.: US 2002/0168221 A1
(43) Pub. Date: Nov. 14, 2002

(54) Threaded coupling structure

(76) Inventor: Karl Hansen, Cottage Grove, MN (US)

Correspondence Address: John F. Klos, Esq., Fulbright & Jaworski L.L.P., Suite 4850, 225 South Sixth Street, Minneapolis, MN, 55402-4320, US

(21) Appl. No.: 10/033,970

(22) Filed: Dec. 20, 2001

Related U.S. Application Data
(60) Provisional application No. 60/290,388, filed on May 11, 2001.

(51) Int. Cl. F16B 1/00; B25G 3/00

(52) U.S. Cl. 403/299

(57) ABSTRACT

The present invention is directed to a threaded coupling structure disposed intermediate a non-threaded first member and a second member having a threaded ring wherein the first member and the threaded coupling structure have cooperating mechanical interlocking structures. The unthreaded portion of said first member and the threaded coupling structure mutually interlock and bind each other when a female-type threaded ring, or a threaded cavity, engages the threads of said threaded coupling. The threaded coupling structure according to the present invention may comprise one or more individual parts which interlock with a portion of the first member. Threads are formed only on surface portions of the threaded coupling structure which threads cooperate to securely engage the threaded ring, or threaded cavity, of the second member. Corresponding discrete interlocking structure formed in or on the first member and a portion of one or more of the individual parts of the threaded coupling structure are adapted to provide additional binding force between the first structure and the threaded coupling.

### STATEMENT OF RELATED APPLICATIONS

This application hereby incorporates by reference and, under 35 U.S.C. §119(e), claims the benefit of priority of U.S. Provisional Patent Application No. 60/290,388, filed May 11, 2001, and entitled, “Threaded Coupling Structure.”

### FIELD OF THE INVENTION

The present invention relates generally to threaded fastening mechanisms for connecting two members. In general, the present invention is directed to an apparatus and method for coupling an unthreaded first member to a threaded boundary of a second member via a threaded coupling structure.

### BACKGROUND OF THE INVENTION

An elongate, or male-type, threaded stud or shank may be fastened to an edge of element in order to secure a female-type threaded structure to the element. For example, welding, soldering, brazing and the like may be used to secure a stud or shank to one side of element. However, the steps of aligning the threaded stud or shank, temporarily securing the stud or shank to the element, welding, soldering or brazing the threaded stud or shank to the element, and then surface finishing the parts are time consuming and inefficient processes. Other prior art approaches to securing a threaded structure such as a threaded knob to an element typically involves forming threads on a portion of the element or creating a threaded aperture or blind hole in the surface of the element. However, the process of forming threads in a portion of the element is time consuming and inefficient whether performed via metal processing (milling, drilling, grinding, etc.), etching, cutting or the like.

Threaded fastening devices have been known. For example, on Dec. 15, 1885, U.S. Pat. No. 332,359 entitled, “Door-Knob Attachment” issued to Paine. In the Paine reference a tapered shank has an interior threaded passageway that engages an intermediate threaded bearing part which in turn encircles a spindle member for a door knob. The threaded bearing part is preferably tapered similar to the shank so that when fully assembled, the shank is securely fastened to the spindle. The bearing part may be a single part or several parts and the spindle formed to engage a bearing part.

U.S. Pat. No. 1,967,145 entitled, “Sealing and Identifying Device for Display Holders” issued to Fisher on Jul. 17, 1934 and discloses an elongated threaded shank having opposing flat, non-threaded surfaces which are inserted into an aperture formed in a plate. Thus, once inserted into the aperture the elongated threaded shank cannot rotate and after a threaded nut is coupled to the end of the threaded shank, the assembly is securely connected.

U.S. Pat. No. 3,922,946 entitled, “Split Bolt” issued to Grayson on Dec. 2, 1975 and discloses a bolt formed of two spaced apart threaded portions and having a wedge member separating the spaced apart sections to promote threaded engagement with a threaded nut. The split bolt may be inserted first into a threaded opening a desired distance and then the wedge member inserted so that the threads of the split bolt engage the threads of the threaded opening.

These and other approaches to using threaded fasteners to couple materials together are comprised of parts that are rotated with respect to corresponding parts to connect them.

### SUMMARY OF THE INVENTION

The present invention is directed to a threaded coupling structure disposed intermediate a first member and a second member having a female-type threaded portion wherein the first member and the threaded coupling structure have cooperating mechanical interlocking structures. The first member and the threaded coupling structure mutually interlock and connect to each other when a female-type threaded ring, or a threaded cavity, engages the threaded portion of said threaded coupling. The threaded coupling structure according to the present invention may comprise one or more individual parts which interlock with a portion of the first member. Threads are formed on surface portions of the threaded coupling structure which threads cooperate to securely engage the threaded ring, or threaded cavity, of the second member. Corresponding discrete interlocking structure formed in or on the first member and a portion of one or more of the individual parts of the threaded coupling structure are adapted to provide additional coupling between the first structure and the threaded coupling. A threaded coupling structure having two or more parts may provide a clamping force to the first member upon engagement with the threads of the second member.

The present invention thus provides an apparatus for connecting a first member to a second member that requires only that an interlocking structure (as defined herein) be formed in, or disposed on, the first member. The interlocking structure operatively engages complementary interlocking structure of the threaded coupling structure. Such an interlocking structure may take many forms. It may comprise a simple round aperture or elongate slot. Additional embodiments may include geometric shaped structures and apertures formed in, extending from, and/or disposed on a portion of the first member and a corresponding portion of the threaded coupling structure. A portion of at least one part of both the threaded coupling structure and the first member preferably have complementary interlocking structures which mutually interlock. The threaded coupling structure has a surface portion with threads disposed thereon, the threads being designed to engage a threaded ring of the second member. The threads of the coupling structure and the threaded ring of the second member may be full or partial threads. Thus, the present invention provides a means of connecting a first member to at least one operative threaded portion disposed on the threaded coupling structure.

Preferably the present invention operates without any adhesives or metal bonding techniques used to connect a threaded member to the first member. A single simple feature formed in the first member may serve as an operative interlocking structure although relatively complex structures may also be used according to the present invention. Such a single feature preferably comprises a slot, a groove, an aperture, a recess, a ridge, a lip, a boss and the like or any combination thereof. Of course, many more such features of diverse shape and size may serve as the interlocking structure and may be used according to the present invention to create the threaded coupling as taught, enabled and illustrated herein.

For example, in an embodiment of the present invention, a first member has relatively closely spaced bores, or holes, formed in a surface of the first member. The threaded coupling structure has pin members which interlock with the bores and an operable male-type threaded portion adapted to engage a threaded ring or threaded cavity of a second member. The threaded coupling structure is thus configured to interlock with and engage the bores formed in the first member and to present an operable male-type thread set designed for the threaded ring. Thus, when the threaded ring engages the operable threaded shank member at the first end, the second end of each complementary part engages and thereby binds the first member thereto. In a refinement of the present invention, the bores, or holes, formed in the first member may have additional interlocking features formed therein (such as a detent, elbow, boss feature and the like). Of course, the threaded coupling structure should have corresponding structure which engages said additional interlocking features.

In one preferred embodiment, the first member is a sheet of material having a single interlocking structure. The interlocking structure is preferably an elongate slot disposed on or adjacent an edge of such material which engages a specially adapted threaded member. A threaded coupling according to the present invention provides a low cost and highly effective means of fastening a generally flat member and a structure having a threaded female-type interior region or cavity. In one embodiment, the threaded coupling structure is configured to be received within a slot of the first member, and engage corresponding threads upon the second member to secure the first and second member together. In another embodiment, the threaded fastener includes a pair of threaded mating components, configured to interlock with a slot of the first member and engage corresponding threads upon the second member to compressively bind the first member to the threaded member.

Another aspect of the present invention is to provided a threaded coupling between a first member having a predetermined thickness at an engaging region, and a second member having an interior threaded cavity having a diameter which is substantially larger than the predetermined thickness of the first member. One or more interlocking structures may be disposed on a part of the engaging region that extends beyond the periphery of the first member or may be disposed both on such an extending part and a non-extending part of the first member. Of course, the interlocking structure may be disposed along a basic non-extending part (e.g., a relatively straight edge portion) of said first member.

Another aspect of the present invention is to provide a slot aperture within the engaging region of the first member, said slot aperture, or notch, sized to cooperate with an adapted threaded coupling structure.

Another aspect of the present invention is to provide a threaded coupling structure as a single unitary component, or alternatively, as a multiple part component.

A further aspect of the present invention is to provide a family of keyed, threaded fasteners that may only be connected at preselected locations in discrete configurations relative to the first member.

Another aspect of the present invention is provided a family of keyed, threaded fasteners that may be axially adjusted to extended more or less from an edge of an engaging region of the first member or over a predetermined range of discrete locations.

The keyed, threaded fasteners of the present invention allows several discrete connecting configurations. Accordingly another aspect of the present invention is to provide keyed, threaded fastening devices which may only be coupled to a first member in a discrete few radial orientations relative to the first member.

The present invention provides several advantages over both prior art and contemporary threaded mechanisms for connecting two members. The present invention may be used to connect raw stock material to other structure or to append a knob or handle to such material. The present invention thus provides a method and apparatus for quickly and easily assembling a threaded structure to a portion of sheet stock and the like. As a result, the present invention is generally lower cost, easier to assemble and maintain, and less prone to breakage than prior art (and complex contemporary) threaded attachment mechanisms.

### BRIEF DESCRIPTION OF THE DRAWINGS

FIG. 1 is a perspective view of representative elements of a prior art approach (before assembly) used to join a terminal end of a sheet of material to a knob having a threaded cavity by welding or soldering a threaded shank to the sheet of material and then engaging the threaded cavity with the threaded shank to join the sheet of material to the knob.

FIG. 2 is a plan view depicting an embodiment of the present invention prior to assembly wherein a threaded coupling structure engages a portion of a first member and the threaded coupling structure is comprised of two interlocking parts which engage each other and a portion of the first member thus holding the two parts in place so that threads formed on surface portions of the two parts engage a threaded ring, or threaded cavity, of a second member.

FIG. 3 is an elevational view of the two parts depicted in FIG. 2 when the two parts are coupled to the first member thus providing a cylindrically shaped threaded region which securely binds the first member to a threaded ring.

FIG. 4 is an elevational view in cross section taken along the lines 4-4 of FIG. 3 and depicting the two parts simultaneously engaging one of the apertures and the first member.

FIG. 5 is a plan view depicting an embodiment of the present invention (prior to assembly) in which a single threaded coupling structure has two spaced apart and generally opposing commonly-threaded regions, a first threaded region disposed on a lower radial portion of the element and a second threaded region disposed on a partially-circular upper portion of an elongated ridge so that the threads disposed on the upper portion of the elongate ridge and the lower semi-circular portion of the element cooperate with the threads disposed in a threaded ring.

FIG. 6 is a plan view depicting a form of the present invention related to the embodiment depicted in FIG. 5 except that the two parts comprise the threaded coupling structure (along only an upper part is depicted in FIG. 6).

FIG. 7 is a perspective view of a form of the embodiment of the threaded coupling structure depicted in FIG. 5 wherein opposing arcuate, threaded regions of the threaded coupling structure cooperate to engage threads disposed on the interior surface of a threaded ring and wherein a flat surface surrounds the elongated ridge feature and said flat surface engages the corresponding flat portion of the first member which surround the elongate slot formed in the first member.

FIG. 8 is an elevational view in cross section taken along the lines 8-8 of FIG. 5 and FIG. 7 which view illustrates the opposing arcuate threaded regions of the threaded coupling structure.

FIG. 9 is a perspective view of a form of the present invention related to the embodiment depicted in FIG. 3, and wherein a pair of pins disposed on a flat portion of a first part of the threaded coupling structure are designed to interlock a corresponding pair of apertures formed in a flat portion of a first member and wherein the first and second parts of the threaded coupling structure are spaced apart but cooperate to form an operable cylindrical threaded shank which securely embraces the first member when the operable threaded shank is coupled to a threaded ring.

FIG. 10 is a perspective view of another form of the embodiment of the present invention depicted in FIG. 9, in which a longitudinal separation of the threaded coupling structure is depicted (in ghost) and an interlocking structure having a geometric lateral cross section (e.g., a triangle-shape) maintains the orientation of the threaded coupling structure relative to a first member when inserted into a similar shape geometric aperture so that the first member is engaged intermediate the first part and the second part along the longitudinal separation.

FIG. 11 is a perspective view of another embodiment that is related to the embodiment depicted in FIG. 3 and FIG. 9 and which is readily adapted for use in joining a non-protruding portion of a first member to a second member via a threaded ring.

FIG. 12 is a perspective view of several possible embodiments and configuration for apertures and recesses which are preferably disposed on or in the first member and adapted to interlock with structure of said threaded coupling structure, and wherein FIG. 12 illustrates several combination of such apertures and recesses which may be used to vary the amount of overlap and the location of the threaded coupling structure relative to the first member.

FIG. 13 is a perspective view of an embodiment of the present invention wherein the threaded coupling structure comprises two complementary parts defining a threaded shank at a first end and a pair of elongated portions at a second end so that said pair of elongated portions may be inserted into a corresponding pair of bores formed in a first member to produce a binding force when the first end is threaded into a threaded ring of a second member.

FIG. 14 is a perspective view depicting another embodiment of the present invention prior to assembly (i.e., prior to engaging a pair of similar V-shaped portion formed in a first member and in a threaded coupling structure) and wherein the pair of V-shaped portions fit together tightly when the threaded coupling structure is threaded into a threaded ring.

FIG. 15 is a plan view depicting yet another embodiment of the threaded coupling member of the present invention wherein two cooperating threaded parts cooperate to form a tapered screw member having interior interlocking structures which engage a portion of a first member and wherein a force exerted upon the tapered screw when rotated into a second member securely binds the assembly together while also connecting a first and a second member.

FIG. 16 is a plan view of the embodiment of the present invention depicted in FIG. 15 coupled on opposing sides of a portion of a first member.

FIG. 17 is an elevational side view of the tapered screw embodiment of FIG. 15 and FIG. 16 except that in FIG. 17 the tapered threaded coupling structure is depicted as having been rotated directly into a portion of a second member.

FIG. 18 is a perspective view depicting another embodiment of the present invention prior to initial assembly (i.e., prior to fitting a threaded coupling structure, having a portion removed that corresponds to the thickness and shape of an edge portion of a first member, to said edge portion).

FIG. 19 is a perspective view of the embodiment depicted in FIG. 18 following initial assembly but prior to threading the cooperating threaded portions together to connect a first member to a second member.

FIG. 20 is a perspective view of another embodiment of the present invention wherein a thread coupling structure having a threaded region at each end thereof, disposed in an aperture formed in the engaging region of the first member so that the threaded ends of the threaded coupling structure cooperatively engage a threaded ring (not shown) to bind the first member to a second member (not shown) via the threaded ring and the end-threaded coupling structure.

### DETAILED DESCRIPTION OF THE PREFERRED EMBODIMENTS

Preferred embodiments of the invention will be described in detail hereinafter with reference to the accompanying drawings, in which like reference numerals refer to like elements throughout.

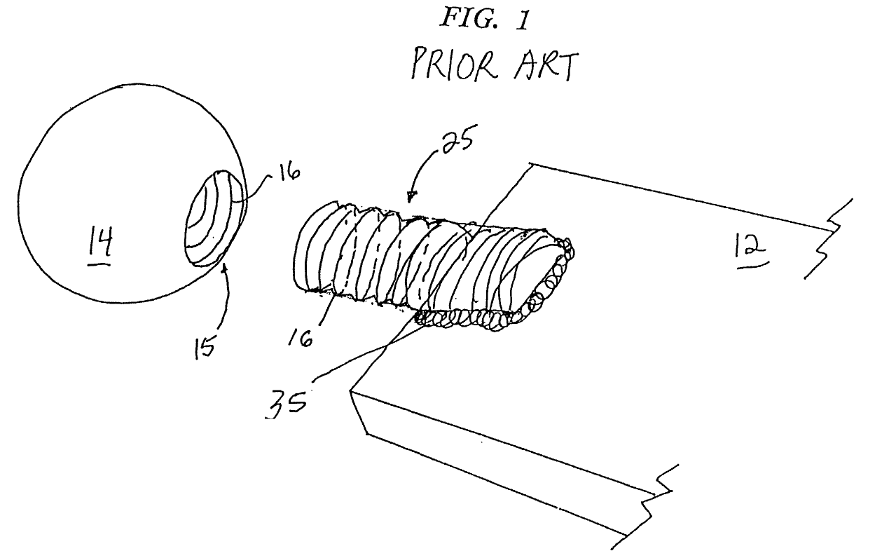

FIG. 1 illustrates a typical prior art approach to joining a terminal edge portion of a first member 12 (i.e., a planar member as depicted in FIG. 1) to a second member 14 (i.e., a knob as depicted in FIG. 1) using a threaded stud or shank 25. In this approach, the threaded shank 25 is welded, soldered or otherwise relatively permanently bonded to the first member 12. A threaded portion 16 of the resulting assembly is readily connected to a threaded interior cavity, or threaded ring 15, of the second member 14. This approach is particularly useful for connecting a threaded shank 25 having a lateral shank diameter that is larger than the thickness of the planar member 12.

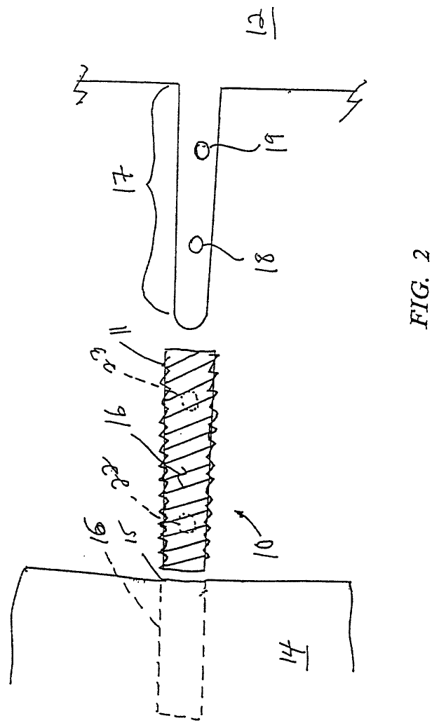

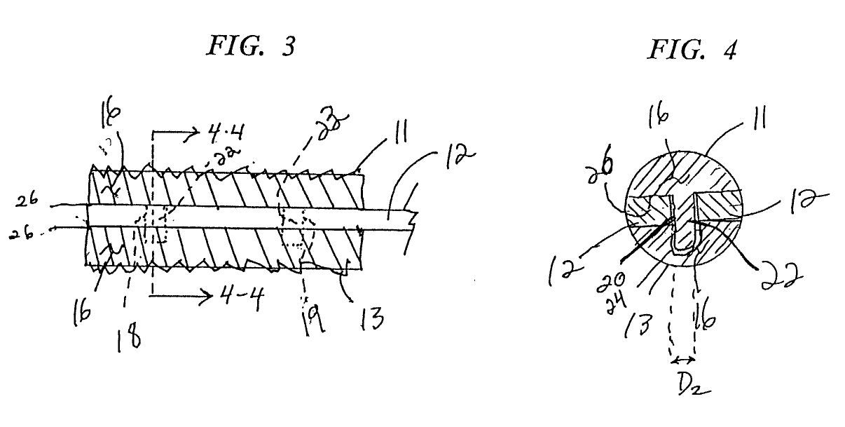

Referring now to FIG. 2, which is a plan view depicting the elements of an embodiment of the threaded coupling structure 10 of the present invention (prior to assembly) adapted to engage an engaging region 17 of a first member 12 which protrudes from an edge thereof. Preferably, at least the engaging region 17 of the first member 12 comprises a thin portion of sheet material or so-called flat stock. The threaded coupling structure 10 comprises two parts 11,13 (part 13 is depicted in FIG. 3) which engage each side of the engaging region 17. The two parts 11,13 connect to the engaging region 17 so that threaded regions 16 formed on a surface of each of the parts 111,13 may operably engage a threaded ring element 15 of a second member 14. The second member 14 may comprise any structure which can support the threaded ring element 15 sized to operably cooperate with threaded regions 16 of the first member 12. The threaded region 16 of the threaded ring element 15 may include full or partial threads. Male-type and female-type threaded regions are denoted herein by the common reference numeral 16. In FIG. 2, the first member 12 is depicted as a relatively flat, thin member having major planar surfaces; although first member 12 may take many other shapes and forms according to the present invention. A pair of apertures 18,19 formed in the engaging region 17 of the first member 12 interlock with pin members 22,23 of the part 11. Of course, just one such aperture 18 or more than one such apertures may be utilized according to the present invention.

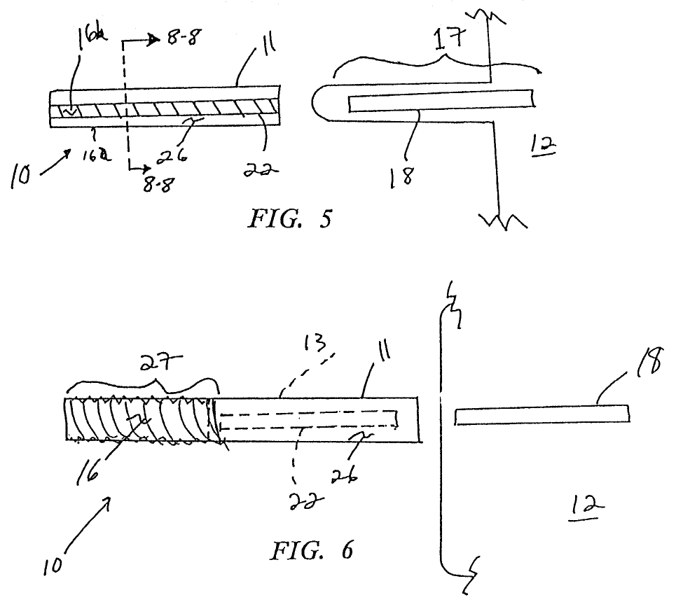

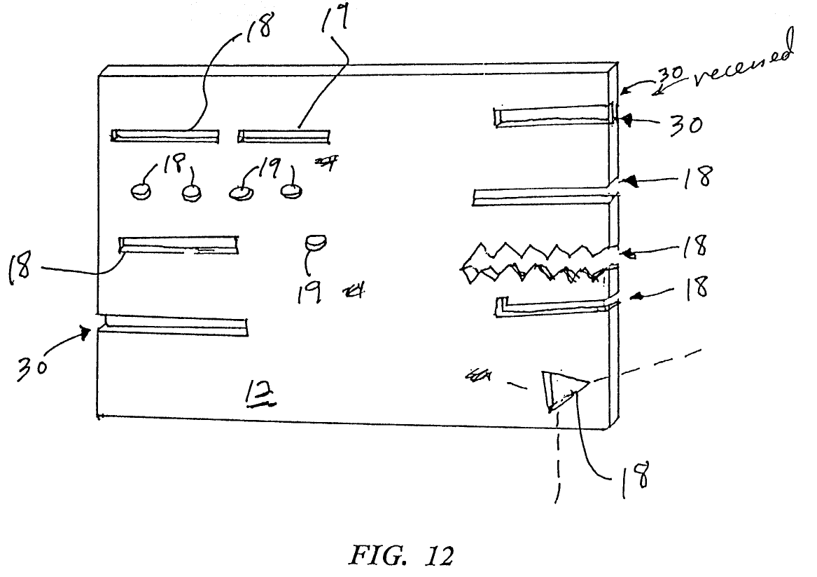

Also, as described and illustrated herein, many different interlocking structures may be implemented in lieu of apertures 18,19 and pins 22,23. In this disclosure, all such structures are referred to herein as interlocking structures regardless of which part they are connected to so long as such structures contact a complementary structure of another part of the assembled coupling. Diverse forms of such interlocking structures may be used in accordance with the present invention, including a pair of dissimilar structures and the like. For example, while apertures and pins are depicted in FIG. 2, an alternative interlocking structure useful in conjunction with the present invention comprises an elongate aperture, or slot (as depicted in FIG. 5 and FIG. 6) and a complementary ridge feature. Other forms of interlocking structures include polygon structures (e.g., a triangle, hexagon and the like) and complementary apertures. As described more fully below, such interlocking structures are used to limit the relative orientation between the first member 12 and the threaded member 10 and therefore may also be used to configure the relative orientation between first member 12 and second member 14. In FIG. 5, FIG. 6, and FIG. 12 a limited number of such interlocking structures are illustrated.

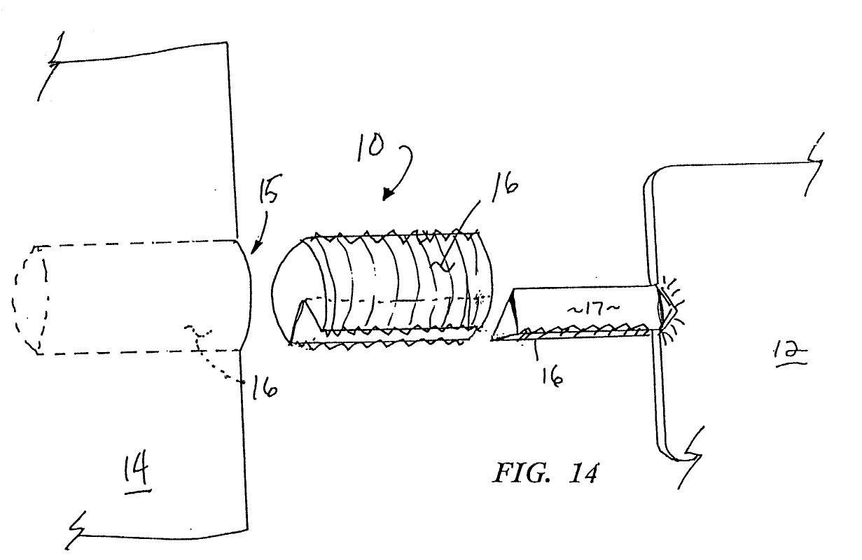

While one alternative form of the threaded coupling structure 10 is disclosed in FIG. 2, other forms of threaded coupling structure 10 can be readily appreciated by those skilled in the art and each is intended to be covered hereby. In general, the threaded coupling structure 10 comprises a mechanical component having partial and/or continuous threaded regions 16 formed on an exterior surface thereof defining an operable threaded structure configured to securely engage internal threads 16 of the second member 14. For reference (and as depicted in FIG. 4 and FIG. 8), in many embodiments of the present invention the threaded coupling structure 10 (or at least one of the opposing parts 11, 13) preferably has an interlocking structure or feature. However (as depicted in FIG. 14), the threaded coupling structure 10 may simply have a portion thereof removed which portion itself constitutes the interlocking structure. The engaging region 17 of the first member 12 should then be configured to engage and interlock with a portion of the threaded coupling structure 10. Accordingly, as depicted in FIG. 14, if a V-shaped portion of the threaded coupling structure is removed, preferably the engaging region 17 of the first member 12 would be similarly V-shaped.

Referring now to FIG. 3, which is an elevational side view, the two parts 11,13 are coupled to the opposite sides of the first member 12 to form a cylindrically shaped, operable threaded region 16. The two parts 11, 13 are bound at surfaces 26 to the engaging region 17 of the first member 12 when a threaded ring 15 is coupled to the threaded region 16. Depending upon element 11,12, 13 dimensions, an amount of compressive clamping force may be generated between the surfaces 26 and the engaging region 27, ranging from a negligible amount to a predetermined value.

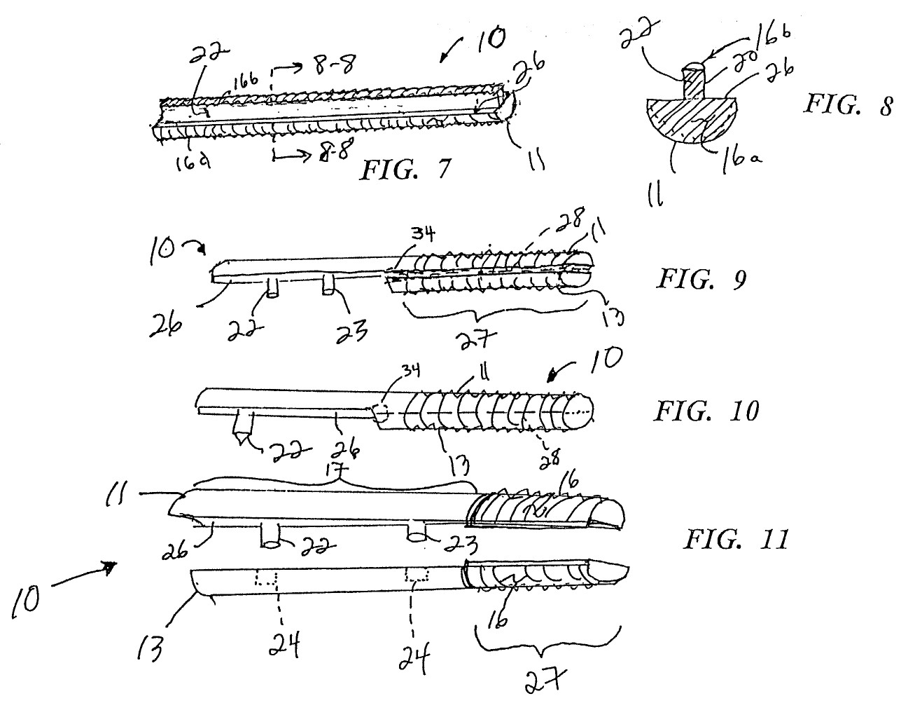

Referring to FIG. 4, which is an elevational view in cross section taken along the lines 44 of FIG. 3, therein depicted is a pin 22 of part 11 simultaneously engaging the aperture 18 formed in the engaging region 17. The pin 22 is seated in bore 24 of part 13. As further illustrated in FIG. 7 and FIG. 8, annular ridges of the threaded region 16 are formed on opposing peripheral portions of the element 10 and together comprise an operative thread set. The annular ridges preferably comprise threads designed to engage the threaded regions 16 of the threaded ring 15. The stem portion of the pin 22 has a flat side portion 20 which abuts the interior surfaces of aperture 18 of the engaging region 17. The interlocking structure 22 has a lateral width dimension which is sized in relation to the aperture 18 of the first member 12, and, the bore 24 into which end of pin 22 is received.

FIG. 5 is a plan view depicting the essential elements of another embodiment of the present invention prior to assembly in which a single threaded coupling structure 10 has two spaced apart generally opposing threaded regions 16, a major region 16a and minor region 16b. The major threaded region 16a is disposed on the semi-circular portion of the part 11 and the minor threaded region 16b is disposed on a smaller semi-circular portion of the part 11 disposed on top of a ridge feature 22. The major threaded region and the minor threaded region are designed to cooperatively engage corresponding threads disposed in the interior of a threaded ring 15 of a second member 14. Flat areas 26 adjacent ridge feature 22 help to promote contact the flat surface of the engaging region 17 of the first element 12 when the ridge feature 22 is inserted into slot 18.

FIG. 6 is a plan view depicting an embodiment related to the embodiment depicted in FIG. 5, adapted so that a ridge feature 22 engages a slot 18 disposed near a non-protruding edge portion of the first member 12. In this form of the invention, each of two opposing parts 11,13 (only part 11 is depicted in FIG. 6) of a threaded shank member may have a portion removed to accommodate the thickness of, and engage each side of, the first member 12. The two parts 11,13 together form a single elongate, commonly-threaded shank member as indicated in FIG. 6 by reference numeral 27. The commonly-threaded region 16 cooperatively engages internal threads 15 of the threaded ring 15 to create a binding force which connects the parts 11,13 to the first member 12. The ridge feature 22 disposed on the first part 11 of the threaded coupling structure 10 is preferably sized to tightly interlock with aperture 18 and preferably also engages the second part 13 (not depicted) and has flat areas 26 adjacent the ridge feature 22 which areas 26 abut the corresponding flat surface of the first member 12.

In a related embodiment (not shown), both the parts 11,13 have a ridge feature 22 slightly offset from the longitudinal center of the threaded coupling structure 10. Thus, when assembled to the first member 12, each slightly offset ridge feature 22 fits into a portion of the space provided by the elongate slot 18. An advantage of this form of the present invention is that each part 11,13 can be identical in size and shape (and location of the offset ridge 22) which reduces inventory and tooling of a threaded coupling structure 10 so constructed. Of course, in lieu of the elongate slot 18, a recess 30, aperture 19 or other surface-to-surface interlocking structure (as depicted in FIG. 12, including analogs thereof) may be used in conjunction with this form of the invention.

FIG. 7 is a perspective view an embodiment of a threaded coupling structure 10 related to that embodiment depicted in FIG. 5 wherein opposing arcuate, threaded regions 16 of the threaded coupling structure 10 cooperate to engage a threaded region 16 disposed on the interior surface of the threaded ring 15. This form of the present invention may be used for connecting a first member 12 having a slot 18 formed adjacent an edge. While other forms of the invention are perhaps better suited, this embodiment may be used for a first member having a slot 18 formed through a peripheral edge.

FIG. 8 is an elevational view in cross section taken along the lines 8-8 of FIG. 5 and FIG. 7 illustrating the opposing arcuate, threaded regions 16 of the threaded coupling structure 10. The threaded regions 16 are disposed on a major arcuate surface (16a) and a minor arcuate surface (16b) of the threaded coupling structure 10. These arcuate surfaces cooperate with the threaded region 16 of the second member 14 to securely connect the first member 12 to the second member 14. In FIG. 8, the side portions 20 of the ridge 22 engage the interior surface of the slot 18 (not shown) and the flat surface 26 is designed to engage the flat surface portions of the first member 12 adjacent slot 18.

In another embodiment of the coupling structure 10 (not shown) similar to that of FIG. 8, the threaded region includes only threads 16a on the major arcuate surface, with a non-threaded region on the opposite arcuate surface. The non-threaded region may be defined along a root diameter of the threads 16a. In operation, the non-threaded region would contact the threaded region 16 of the second member 14.

FIG. 9 is a perspective view of an alternate embodiment of the embodiment initially depicted in FIG. 3. In FIG. 9, a pair of pins 22,23 are designed to engage a corresponding pair of apertures 18,19 (not shown) which are disposed in the engaging region 17. A longitudinal line of separation 28 of the threaded coupling structure 10 is depicted (in ghost). The first end of the threaded coupling structure 10 is comprised of two parts 11,13 which together form a cylindrical member having threaded regions 16 thereon. The second part 13 has a flat region 26 where the pair of pins 22,23 are located so that the pins 22,23 can interlock with corresponding apertures 18,19 (not shown) when the two parts 11,13 embrace opposite sides of the first member 12. An interior portion 34 of the threaded coupling structure 10 may be removed to accommodate a limited engagement with a portion of the first member 12. Of course, in this form of the present invention (and analogous forms), the length of the threaded coupling structure 10 may also be adjusted to accommodate the desired separation of the first member 12 from the second member 14.

FIG. 10 is a perspective view of another embodiment of the present invention in which a longitudinal line of separation 28 of the threaded coupling structure 10 is depicted (in ghost) and a single interlocking structure (i.e., a triangle-shaped boss) maintains the orientation of the threaded coupling structure relative to the first member 12 when said first member 12 is engaged along the longitudinal line of separation (shown in ghost as reference numeral 28). In this form of the invention, only the end portions 27 of the two parts 11,13 (that extend from the side of the first member 12) have threaded regions 16 disposed thereon. As described above with respect to FIG. 9, an interior removed portion 34 of the threaded coupling structure 10 may promote sure engagement with the first member 12. Also, the length of the entire assembly may be modified to provide a desired spacing between the first member 12 and the second member 14. This form of the present invention permits only a limited number of discrete orientations between the first member 12 and the threaded coupling structure 10 when fully assembled. As depicted in FIG. 10, due to the triangular shape of the interlocking structure 22, only three such discrete orientations are permitted, thus potentially reducing incorrect final assembly thereof while at the same time promoting alignment between the operative parts.

FIG. 11 is a perspective view of another embodiment (related to the embodiment depicted in FIG. 3 and FIG. 9) which is readily adapted for use in joining a non-protruding portion of a first member 12 to a second member 14 by simply increasing the length of the two parts 11,13. In this form of the invention, only the end portions 27 of the two parts 11,13 that extend from the side of the first member 12 have threaded regions 16 disposed thereon. Optionally, and as noted above with respect to FIG. 9 and FIG. 10, portions of the first member 12 corresponding to the area of the flat surface 26 may be removed so that the part 11 abuts the part 13 where said parts are inserted into the threaded ring 15 and cooperatively interlocks at the engaging region 17 of the first member 12. Thus, when the threaded coupling structure 10 is connected to the first member 12 the operably threaded end 27 of the parts 11,13 form an operable threaded coupling surface which is received by the threaded ring 15. Of course, in addition to or in lieu of removing a portion of the parts 11,13 one or more recessed areas 30 (examples are shown in FIG. 12) may be formed in the first member 12 to better align the two parts 11, 13 in the preferred abutting and parallel relation.

In addition, the two parts 11,13 are preferably designed and constructed for a predetermined thickness of material comprising the first member 12. In the event that the thickness of the first member 12 is less than the predetermined thickness, one or more of a shim member, a bushing member or a spacing member and the like may be inserted between the two parts 11,13 to effectively increase the thickness of the first member 12 to the predetermined thickness. In the event that the thickness of the first member 12 is greater than a predetermined thickness, each cooperating threaded region 16 of the two parts 11,13 may be formed on a smaller portion of the surface portions of the two parts 11,13.

FIG. 12 is a perspective view of several possible embodiments and configurations for interlocking structures disposed on or in a first member 12. FIG. 12 illustrates several combinations which may be used to adjust the amount of overlap and location of the threaded coupling structure relative to the first member 12. For example, as depicted in FIG. 12, elongate slots 18,19 may be used to receive two pin members, ridge features having diverse length dimensions (albeit less than the length of the elongate slots 18,19) or other interlocking structures. Thus, threaded coupling structure 10 may be adjusted over a range of mounting locations defined by the length of the slots 18,19. In addition two aligned aperture pairs may be used to provide discrete mounting locations and adjustability to the coupling. A pin 22 may fit into one aperture of a set of apertures 24 which each are spaced from on edge of the first member 12, thus defining a set of discrete mounting locations. Of course, one or more recesses 30 may be used to interlock with corresponding structure of the threaded coupling structure 10. Such recesses 30 may be on one side or on opposing sides of the first member 12. Furthermore, any of the interlocking structures depicted, illustrated or described may extend to the edge of the first member 12; however, to restrict axial movement and possible failure of the coupling, geometric shaped structure, such as a saw-tooth shaped slot (or recess), an L-shaped slot (or recess) and the like may be used to promote the interlock therebetween.

Furthermore, and continuing with respect to the features depicted in FIG. 12, many of the embodiments of the present invention are designed to provide adjustability to the threaded coupling member 10 and the ultimate mounting location. In several embodiments the threads of a operative threaded portion 16 is disposed on different parts 11,13. The threaded region 16 of the parts 11,13 may be offset axially and still provide a common operable threaded surface 16, even though one of said respective threaded surface regions 16 may extend beyond another of said threaded surface regions 16. Regular or irregular shapes in, on or below the surface of the first member 12 which interlocks with and engages a portion of the threaded coupling structure 10 may be used regardless of axial offset between the elements. As depicted in FIG. 12, one such interlock structure is a sawtooth-shaped ridge and aperture pairing which provides a series of discrete coupling locations. As depicted in FIG. 12, this form of the invention may be very useful in the embodiments having a slot 18 that extends to the periphery of the first member 12, to prevent axial motion (or separation) between the assembled parts. Also depicted is a form of interlocking structure having one or more shallow recesses 30 (or pair of opposing recesses 30) formed in the first member 12.

To fabricate the operative elements of the threaded coupling structure 10 of the present invention a variety of techniques may be used. For example, the aperture, slot or other interlocking features associated with the engaging region 17 of the first member 12 may be formed by drilling, milling, etching, punching, too and die, grinding, cutting, molding and the like. The threaded regions 16 of the present invention may be of any useful pitch, depth, spacing and frequency that are compatible with corresponding threaded region 16. However, in one form of the present invention the threaded regions 16 are intentionally non-uniform at or near the limit of desired travel of the threads so that the threaded portions 16 are effectively locked together upon the first assembly thereof.

A further set of embodiments may be fabricated and used according to the present invention wherein the two parts 11,13 that form the threaded coupling structure 10 each interlocks a pair of recesses 30 formed at the periphery of the first member 12. The recesses 30 may be tapered or may have variation in width and/or depth to promote the interlock with complementary structure of the parts 11,13.

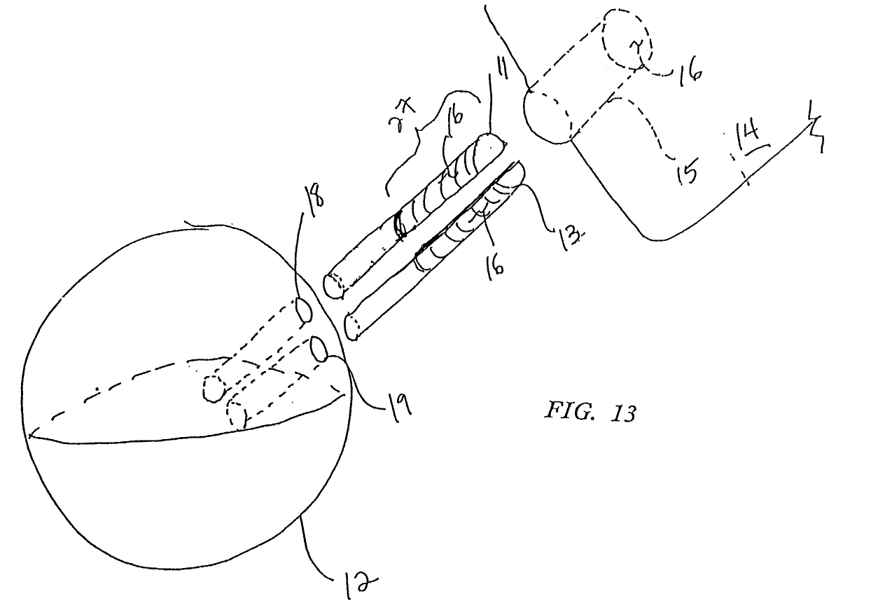

FIG. 13 is a perspective view of an embodiment of the present invention wherein the threaded coupling structure 10 comprises two complementary parts 11,13 which together define a threaded shank having operable threaded regions 16 disposed at a first end 27 and a pair of unthreaded elongated portions terminating at a second end. The pair of elongated portions are inserted into a corresponding pair of bores 18, 19 formed in a first member 12. The operable threaded regions 16 are together inserted into threaded ring 15 of second member 14 to complete the coupling therebetween. While two complementary parts 11,13 are depicted in FIG. 13, more than three individual parts may be utilized to perform substantially as depicted and described. For example, three complementary parts may each be inserted into a corresponding bore formed in a first member and may together from an operable threaded coupling structure 10 adapted to engage a threaded ring 15 of a second member.

FIG. 14 is a perspective view depicting another embodiment of the present invention prior to assembly (i.e., prior to engaging a non-threaded V-shaped elongate portion of a first member). In this form of the invention, a threaded coupling structure 10 is comprised of a cylindrical, threaded shank with a V-shaped section removed therefrom (as viewed in lateral cross section). The removed section corresponds to the elongated portion of the first member 12 so that when the two complementary, interlocking V-shaped parts interlock, the first member 12 and the threaded coupling structure 10 are retained in place so that threads formed along a portion of the periphery of the threaded coupling structure 10 engage a threaded ring 15 of a second member 14.

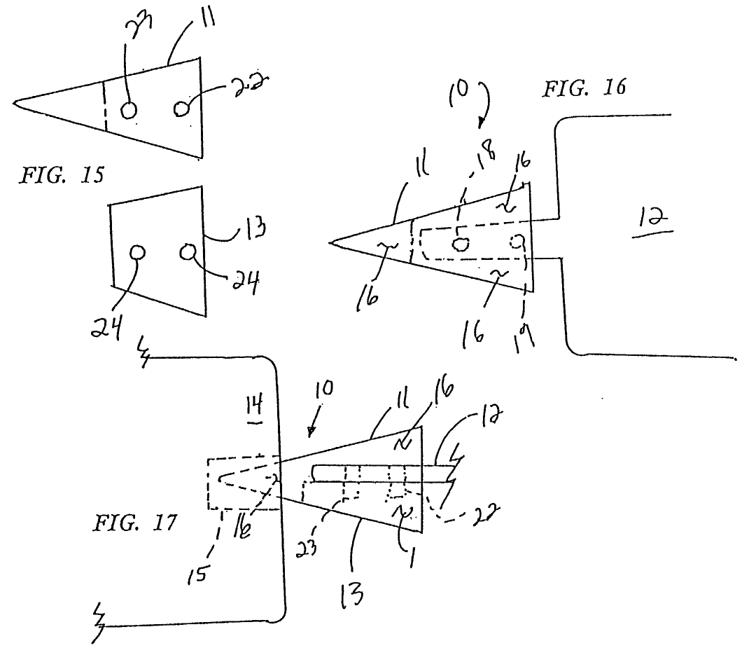

FIG. 15, FIG. 16 and FIG. 17 each depict yet another embodiment of the present invention wherein in lieu of a cylindrical shaped threaded coupling structure 10, a conical or tapered threaded coupling structure 10 is used which imparts a binding force to the first member 12 when the tapering coupling element 10 is screwed into the second member 14.

In FIG. 15 two cooperating threaded parts 11,13 cooperate to form a tapered screw-type coupling structure 10 with interior structures 22,23 interlocked with a similar-shaped pair of structures 18, 19 of a first member 12, and wherein the ends of structures 22,23 are seated in the pair of bores 24. In this embodiment, a compressive force exerted upon the exterior of the tapered screw 10 as it is rotated into a second member 14 securely binds the threaded coupling structure 10 to the first member 12. In this embodiment of the present invention the thread coupling structure 10 may be simply rotated into a non-threaded borehole in the second member 14 or directly into a surface of the second member 14. In this embodiment, the parts of the threaded coupling structure 10 are preferably designed so that they do not separate during final attachment to said second member 14.

FIG. 16 is a plan view of the embodiment of the present invention depicted in FIG. 15 coupled to a portion of a first member 12.

FIG. 17 is an elevational side view of the tapered screw form of the threaded coupling structure 10 of the present invention, as previously depicted in FIG. 15 and FIG. 16. In FIG. 17 the tapered threaded coupling structure 10 is shown as having been rotated directly into a surface portion of a second member 14. Shown in ghost in FIG. 17 is an outline for a non-threaded bore hole 15 which receives the threaded coupling structure 10 and is used to help align the parts during assembly.

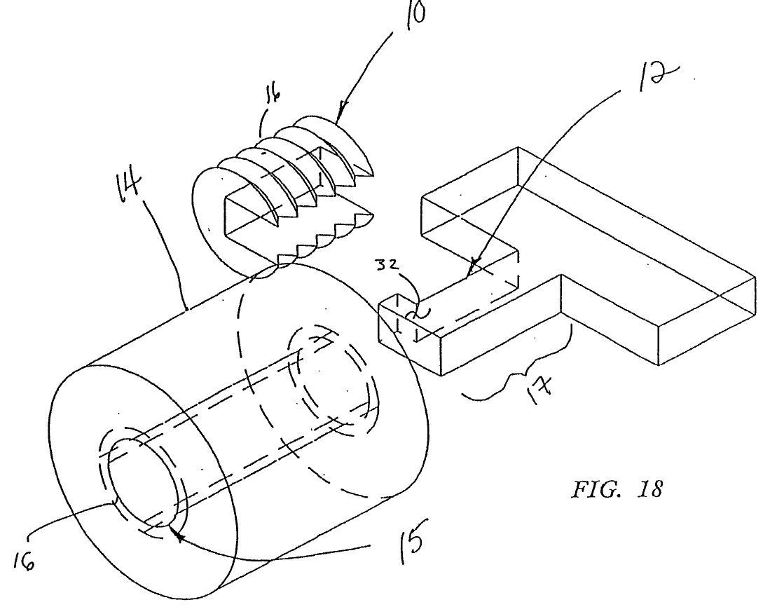

FIG. 18 is a perspective view depicting another embodiment of the present invention prior to initial assembly (i.e., prior to fitting a threaded coupling structure 10, having a portion removed that corresponds to the thickness and shape of an edge portion of a first member 12, to said edge portion). In this embodiment, an elbow or tang feature 32 formed at the distal end of the engaging region 17 limits axial movement of the threaded coupling structure 10 prior to and after assembly.

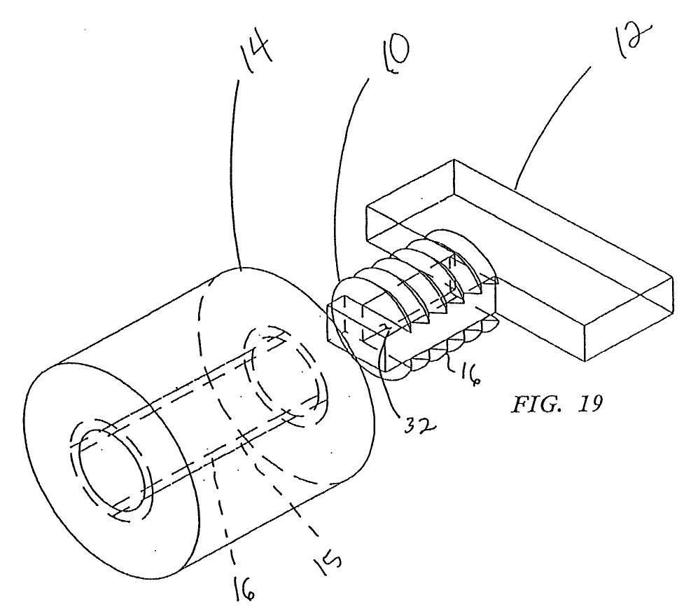

FIG. 19 is a perspective view of the embodiment depicted in FIG. 18 following initial assembly but prior to threading each cooperating threaded region 16 into ring 15 to connect a first member 12 to a second member 14.

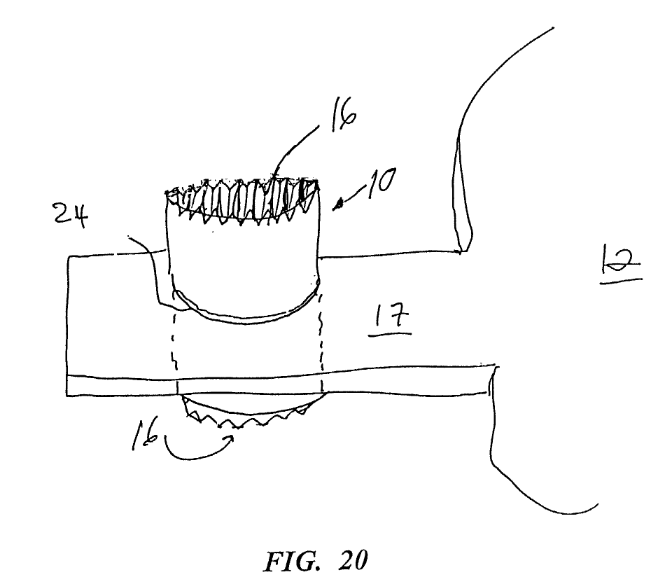

FIG. 20 is a perspective view of another embodiment of the present invention wherein a thread coupling structure 10 having a threaded region 16 at each end thereof, disposed in an aperture 24 formed in the engaging region 17 of the first member 12 so that the threaded ends of the threaded coupling structure 10 cooperatively engage a threaded ring 15 (not shown) to bind the first member 12 to a second member (not shown) via the threaded ring and end-threaded coupling structure 10. More than one such end-threaded coupling structure 10 may be used to couple the first member 12 to the second member 14.

The following examples are intended to further illustrate the present invention as including methods and apparatus for practicing the teaching of the disclosure of the invention.

### EXAMPLE 1

A method of connecting a first member to a second member, said second member including an internal thread set, said method comprising the steps of:

A. forming an interlocking structure in an engaging region of a first member;

B. engaging the interlocking structure with a portion of a threaded coupling member, said portion corresponding to a part of the interlocking structure; and

C. rotating a portion of the threaded member into engagement with the internal thread set of the second member until the first member and the second member are securely connected.

### EXAMPLE 2

A threaded coupling apparatus for joining a threaded member to a first member so that a second member may be connected to the threaded member, comprising:

a first member having an interlocking structure disposed on a surface thereof;

a threaded coupling member having a portion correspondingly configured to engage the interlocking structure when coupled to the first member, said threaded coupling member forming an elongate threaded engaging portion; and

a second member having a threaded cavity configured to receive the threaded engaging region and wherein said second member securely binds the first member to the threaded member and connects the second member to the elongate threaded engaging portion.

### EXAMPLE 3

A method of connecting a first member to a second member by producing a binding force imparted by a threaded cavity of a second member, comprising the following steps:

A. forming an interlocking structure in an engaging region of a first member;

B. engaging the interlocking structure with a portion of a threaded coupling member corresponding to a part of the shape of the interlocking structure;

C. inserting a portion of the threaded coupling member and a portion of the engaging region into a threaded cavity of the second member; and

D. rotating the second member relative to the first member until the first member and the second member are securely connected.

### EXAMPLE 4

An apparatus for connecting two members together using a binding force provided by a threaded ring when engaged to an elongate threaded member, comprising:

a first member having opposing major surfaces and an engagement region adjacent an edge of said first member and a first half of an interlocking structure disposed on said engagement region;

an elongate threaded member having a first external thread disposed on a portion of the exterior surface of said elongate threaded member and having a second half of the interlocking structure and said second half of the interlocking structure is connected to said first half of the interlocking structure; and

a threaded ring member having a second thread set disposed on the interior of said threaded ring member that correspond to said first thread set and wherein said threaded ring member encircles the first half and the second half of the interlocking structure and binds the first member and the elongate threaded member and the second member together.

Finally, while fairly uniform discrete slot, aperture, pin, peg, geometric and ridge features and other similar and dissimilar features and combinations thereof have been depicted and described herein, the present invention is not limited to only such forms of interlocking structure as those illustrated and described. In fact, the use of asymmetrical features may be used to promote a secure connection between the parts and to prevent inadvertent erroneous assembly. In additional embodiments of the present invention, material or structure may be used to retain the operative parts in place during assembly. Some representative materials include adhesive materials, tape materials, gasket materials, and the like. These materials may be destroyed during final assembly or may form part of the finally assembled unit. Structure according to this form of the present invention may include a layer of material to provide a “thread lock” type connection on the threaded coupling structure 10 and/or the threaded ring 15.

Additional advantages and modifications of the present invention will readily occur to those skilled in the art. The present invention in its broader aspects is, therefore, not limited to the specific details, representative apparatus and illustrative examples shown and described. Accordingly, departures from such details may be made without departing from the spirit or scope of the applicant's general inventive concept and are intended to be covered hereby.

I claim:

1. An apparatus for joining a first member to a second member via a threaded coupling member, said apparatus comprising:
a first member having an interlocking structure disposed at an engaging region;
a threaded coupling member having an external thread set and having a complementary portion corresponding to a portion of the interlocking structure; and
a second member having an internal thread set adapted to engage a portion of the external thread set of the threaded coupling member and to receive a portion of the engaging region of the first member within the internal thread set to thereby connect the second member to the first member.

2. An apparatus according to claim 1, wherein the first member is a planar element.

3. An apparatus according to claim 1, wherein the interlocking structure is formed in a region adjacent an edge portion of the first member.

4. An apparatus according to claim 1, wherein the interlocking structure is more than one interlocking structure.

5. An apparatus according to claim 1, wherein said interlocking structure is a selected one from among the group including: a slot, a groove, an aperture, a recessed portion, a blind hole, a pin, a shank, a ridge feature, a tang, a serpentine feature, an elbow feature, and a lip feature.

8. An apparatus according to claim 1, wherein the threaded coupling member has a larger diameter dimension than a thickness dimension of the first member.

9. A method of connecting two members via a threaded coupling member, comprising the steps of:
a. forming an interlocking structure in an engaging region of a first member;
b. forming a threaded coupling member having a portion which is complementary to the interlocking structure;
c. engaging the interlocking structure with the portion of a threaded coupling member;
d. engaging a portion of the threaded coupling member and a portion of the first member with an internal thread set of a second member; and
e. rotating the second member relative to the first member until the first member and the second member are securely connected.

10. A method according to claim 9, wherein the interlocking structure is a selected one from among the group including: a slot, a groove, an aperture, a recessed portion, a blind hole, an aperture, a pin, a shank, a ridge, a lip, an elongate ridge structure, an elbow-shaped feature, a serpentine feature, a tang, and a boss.

11. A method according to claim 9, wherein the step of forming the threaded coupling member includes the step of forming a plurality of components which comprise the threaded coupling member.

12. An apparatus for connecting two members together using a binding force provided by an internal thread set of one of the two members, said apparatus comprising:
a first member having a pair of opposing major surfaces, an engaging region on at least one of the major surfaces, and an interlocking structure disposed at said engaging region;
an elongate threaded coupling member having an external thread set and an engaging portion corresponding to the interlocking structure of the first member, said threaded coupling member removably engaging each of the pair of major surfaces of the first member and removably engaging the interlocking structure; and
a second member having an internal thread set sized to cooperate with the external thread set of the threaded coupling member, wherein when said external thread set of the threaded coupling member is threadedly received within the internal thread set said threaded coupling member securely binds the first member to the second member.

13. An apparatus according to claim 12, wherein elongate threaded coupling member is two longitudinal portions of a threaded shank each having an threaded exterior surface and a substantially flat interior surface.

14. An apparatus according to claim 12, wherein the interlocking structure is a pair of pin members coupled to the substantially flat interior surface of one of the two longitudinal portions of the threaded shank.

15. An apparatus according to claim 12, wherein the thickness of the first member is less than a diameter of the internal thread set.

16. An apparatus for joining two members via a threaded coupling member, said apparatus comprising:
a first member having an interlocking structure disposed proximate an edge;
an elongate threaded coupling member having an external thread set and an engaging portion corresponding to the interlocking structure of the first member, said threaded coupling member removably engaging the interlocking structure and extending away from the edge of the first member; and
a second member having an internal thread set sized to cooperate with the external thread set of the threaded coupling member, said internal thread set operatively receiving a portion of the external thread set of the threaded coupling member and a portion of the first member to securely bind the first member to the second member.

17. An apparatus according to claim 16, wherein the interlocking structure is more than one interlocking structure.

18. An apparatus according to claim 16, wherein the elongate threaded coupling member includes a partial thread set having a first arcuate thread portion and a second, generally opposite, substantially smaller arcuate thread portion.

19. An apparatus according to claim 18, wherein the second arcuate thread portion is sized to pass through an aperture of the first member.

20. An apparatus for joining two members via a threaded coupling member, said apparatus comprising:
a first member having an portion extending from an edge and defining an interlocking structure;
an elongate threaded coupling member having an external thread set and an engaging portion corresponding to the interlocking structure of the first member, said threaded coupling member removably engaging the interlocking structure;
a second member having an internal thread set sized to cooperate with the external thread set of the threaded coupling member, said internal thread set operatively receiving a portion of the external thread set of the threaded coupling member and a portion of the first member to securely bind the first member to the second member.

21. An apparatus according to claim 20, wherein the elongate threaded coupling member includes a removed channel portion sized to receive an elbow-shaped portion of the interlocking structure.
